(19) United States
(12) Patent Application Publication
(10) Pub. No.: US 2014/0301155 A1
(43) Pub. Date: Oct. 9, 2014

(54) Portable Battery Operated Blender

(71) Applicant: Adam Lee Montgomery, Genoa City, WI (US)

(72) Inventor: Adam Lee Montgomery, Genoa City, WI (US)

(21) Appl. No.: 13/856,593

(22) Filed: Apr. 4, 2013

(51) Int. Cl. B01F 15/00

(52) U.S. Cl. CPC B01F 15/00519
USPC 366/142

(57) ABSTRACT

Provided is a portable blender that is powered by power tool batteries. The blender has a base housing, a blender jar, and a removable lid. Indicator lights are disposed along the base to provide visual reference of the blender's operating mode. This is accomplished by a coordination of indicator light illumination patterns and colors with the blender's current operating mode. The blender is universally compatible with power tool batteries, which can be plugged into a battery recess in the blender base, or may be connected via a battery extension connector. In this way, the invention provides a portable appliance that is powered by unhand tool batteries rather than requiring specialized power sources.

### CROSS REFERENCE TO RELATED APPLICATION

This application claims the benefit of U.S. Provisional Application No. 61/620,030 filed on Apr. 4^{th}, 2012, entitled “Blenderooski”. The patent application identified above is incorporated here by reference in its entirety to provide continuity of disclosure.

### BACKGROUND OF THE INVENTION

1. Field of the Invention

The present invention relates to a portable kitchen appliance. More specifically, it relates to a battery powered blender. The blender has indicator lights that illuminate according to the current setting of the blender. Instead of conventional battery assemblies, the present blender utilizes power tool batteries as a battery source. In this way, users can switch out batteries between their power tools and the blender and eliminate the need for storing additional sets of batteries.

Blenders were originally invented at the turn of the century to speed up the process of making, “malts”, also known as malted milk shakes. The blender provided a quick and easy way to blend the malt powder with milk to create a beverage that was thought that the time to boost health and vitality. Though the machines gained popularity in ice cream parlors, also known as “soda fountains”, it was the rumored health benefits that resulted in continued developments and improvements to the device. Medical science reports indicated that liquefied food diets were beneficial to people with ulcers which lead to the mass marketing of the blender as a must-have for any household containing a person with a sensitive stomach.

Today, blenders are a staple of the average American home. The blender is used to crush ice, liquefy soft foods, chop fruit, and create smoothies. These cold beverages having a thick and regular consistency were thought at one time to be beneficial to those with stomach ulcers, and other gastrointestinal ailments.

Modern blending devices come in many sizes, power output capacities, and shapes. Additional elements, interchangeable parts, and combination devices have been created to further meet the varied cooking needs of diverse user groups. Commonly blended foods include fruits, vegetables, and beverages, which combine in the appliance to create an evenly distributed mixture.

The size and power needed by conventional blending devices limits their use to kitchen and bar areas. This configuration can be obnoxious to people hosting outdoor parties or travelers, who wish to make smoothies and shakes while away from home. Battery powered blenders have been created to solve this problem, and provide hosts and travelers with a food blending means that does not require a wall outlet. But these portable blenders have limited battery supply that must be recharged between uses. If the batteries die during use, the partygoers may be stuck without blended beverages until the batteries can be recharged. A portable blender is needed that can interchangeably use batteries from other devices to power the blender.

### DESCRIPTION OF THE PRIOR ART

The present invention is a portable blender that is adapted for use with a variety of power tool batteries. The batteries may be plugged into a battery recess on the side of the blender, or alternatively may be connected with a power connector extension. This extension is a set of wires connected to the blender base and a battery connector. The battery connector engages with the terminals on a power tool battery. Lights disposed along the base of the blender device illuminate according to the blender's current mode of use. The following is a list of devices deemed most relevant to the disclosure of the present invention.

Kubicz, U.S. Pat. No. 6,193,407 discloses a battery-operated portable blender device. It has a base with upstanding sidewalls, a supporting surface at the top of the side walls, and elastomeric surface on the bottom. A blender jar is included, and removably mounts to the support surface during use. Food items placed within the blender are mixed and liquefied into a regular consistency. Because the blender is battery operated, it can be used both in the kitchen and outside of the home. A battery compartment disposed along the bottom of the device has a door, secured to the base by hinge on one edge and a flange on another edge. The door is opened to insert and remove batteries as needed.

Another portable blender is disclosed in Sands, U.S. Pat. No. 7,422,362. Like the Kubicz device, Sands teaches a portable blender with a battery storage compartment disposed on the bottom of a base unit. A blending container is removably secured to the top of the base when the device is in use. In the preferred embodiment the blending container is a single serving cup. This feature allows individual use of the blender device. By way of example, the a first user can place a first blending container on the base, pour beverages in the container, mix them, then remove the container and drink directly therefrom; a second user can then repeat the process with her own blending container. The Sands device is pressure activated, rather than utilizing the conventional dials and rocker switches of most blenders. Pressure is applied to the blender container to facilitate blending, and removed when a desired beverage consistency is achieved.

A portable juicer that converts into a blender is disclosed in Stuckey, U.S. Patent Application Publication No. 2005/0229795 The device has a base that houses the motor and battery storage compartment. A juicing bowl, grinding disk, pulp catcher, lid and feeding spout are nested on top of the base. When the device is in use, fruits and vegetables inserted into the feeding spout are ground up and their juice filtered out into the juice bowl. Pulp is caught, separating it from the juice for easy clean up. A circular ring of blender blades may be used to replace the grinding disk, thereby turning the device into a portable blender.

Lastly, Boyce, U.S. Pat. No. 4,487,509 teaches another portable battery operated blender. A blending container is included with a removably securable lid. Blending blades are secured to the interior of the lid, which is connected to the device base when in use. Thus the blending container is inverted during blending and then turned right side up, after blending is completed. This structure allows the blending container to be used as a regular beverage pitcher and does not present the hazard of blending blades in the bottom of the container. The blender's drive assembly is battery operated by rechargeable batteries. These batteries can be recharged through the device's optional dc connection.

These prior art devices have several known drawbacks. Each of the devices described above uses rechargeable batteries that are inserted and stored within the device base. If these batteries die while the device is in use, the user is forced to cease operation of the device and recharge the batteries. The present invention provides a means for using interchangeable batteries in the form of power tool batteries. Power tool batteries may be inserted into a port or may be connected via a power extension connector. Users can disconnect batteries from their power tools and hook them up to the blender as needed to maintain a regular stream of power. Further, the present invention has a band of indicator lights disposed around the base to indicate an operating mode to the user. Thus, the present invention substantially diverges in design elements from the prior art and consequently it is clear that there is a need in the art for an improvement to existing portable blending devices. In this regard the instant invention substantially fulfills these needs.

### SUMMARY OF THE INVENTION

In view of the foregoing disadvantages inherent in the known types of portable blenders now present in the prior art, the present invention provides a new power tool battery connector wherein the same can be utilized for providing convenience for the user when switching out battery supplies.

It is therefore an object of the present invention to provide a new and improved portable blender device that has all of the advantages of the prior art and none of the disadvantages.

It is therefore an object of the present invention to provide a portable blender that can be electrically connected to power tool batteries of various models.

Another object of the present invention is to provide a portable blender having a port on one side that receives the terminal end of a power tool battery.

Yet another object of the present invention is to provide a portable blender that has a multitude of indicator lights disposed on the base, that illuminate according to the blender mode in use.

Still another object of the present invention is to provide a durable and versatile blending appliance that can be used both in and out of the kitchen.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the portable blender in an assembled state with the graduated container affixed to the top of the blender base. Indicator lights are illuminated around the periphery of the base.

FIG. 2 shows a rear view of the blender base. Two rows of illuminated indicator lights are disposed on laterally opposing sides of the base, and the battery access plug is in place.

FIG. 3 shows a rear view of the blender base. The batter access plug is opened and a power tool battery is being inserted.

FIG. 4 shows a rear view of an alternative embodiment wherein the power connector extension protrudes from within the battery recess in use.

### DETAILED DESCRIPTION OF THE INVENTION

Reference is made herein to the attached drawings. Like reference numerals are used throughout the drawings to depict like or similar elements of the portable blender. For the purposes of presenting a brief and clear description of the present invention, the preferred embodiment will be discussed as used for mixing food products and beverages. The figures are intended for representative purposes only and should not be considered to be limiting in any respect.

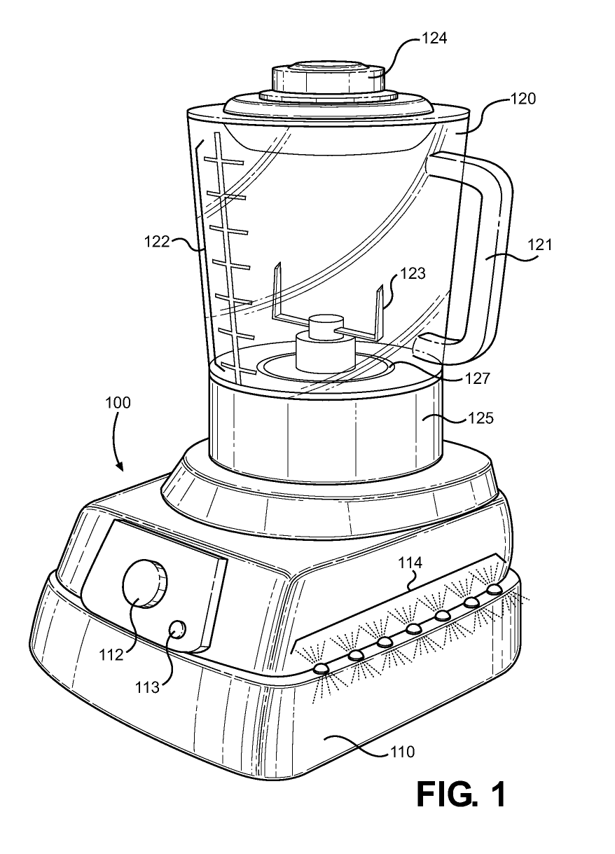

Referring now to FIG. 1, there is shown an assembled blender with the blender container positioned on top of the blender base. The portable blender 100 comprises a blender base 110, also known as the blender housing, a graduated container 120 or blender jar, a blender blade 123 secured to a sealing ring 127, a container base 126, and a removable lid 124.

The blender container is a funnel-shaped jar made of glass, acrylic, other plastic, or metal. Funnel-shaped containers are preferred because their shape encourages food to slide down the interior surface towards the blender blades. The container has graduated measuring indicia 122 disposed on one side of the jar, facilitating easy measurement of liquefied or emulsified contents within the container. Measuring indicia may be engraved, embossed, or printed, on the container exterior. A handle 121 is disposed on one side of the blender container, making it easy to pick the jar up and move it off the blender base.

In a preferred embodiment, the blades 123 and sealing ring 127 are all secured to the container base 125. Blender containers 120 may be permanently or removably secured to the container base. The blade fits snuggly into the sealing ring, which fits into the container base to prevent liquids from seeping out of the jar. These elements may be separate and removable to facilitate easy cleaning or may be permanently nested within one another. Multiple blade configurations are contemplated and it is to be understood that the blender blades are not limited to the two mixing blades shown in the figure. Many blenders have three or four blades that may be co-planar or may extend in different directions at varied angles. The blades may be made of stainless steel or other wear resistant metal to maximize cutting capability.

A weighted blender base houses the motor and mode of operation controls. The blender base 110 has an upwardly tapering shape that begins at a broad flat base and moves inward as it reaches the blender container coupling. Contained within the base is a high-speed motor that is battery powered and fan cooled. The motor is operatively connected to a coupler that protrudes from the upper most area of the blender base. When the blender container is secured to the blender base, the coupler, a clutch or serrated drive, engages with the blender blades. A power button 113 and mode selection dial 112 control the operating mode of the blender. Motor and drive selection is well known in the art of small electronic appliances and it will be understood by one of ordinary skill in the art that minor modifications to the above described components are permissible without changing the operation of the device.

One or more rows of indicator lights 114 are disposed along a portion of the blender base 110 periphery. The lights may be individual bulbs or may be light strips made of a translucent material with individual bulbs contained within the strip. Alternatively, they may also be fiberoptic filaments. The lights are electrically connected to the mode of operation controls, such that varying the mode of operation results in a change in illumination pattern. By way of example, the lights may illuminate in a solid, unbroken pattern when the blender is on but not in use; and may blink, illuminate in patterns, or illuminate in a different color when the blender is in use. Different colors or patterns are associated with each mode of operation. These indicators will make it easy for persons away from the blender to determine if the appliance is in operation. People at parties and tailgates can quickly recognize whether the blender has been left on and unattended, and then turn the blender off. This will reduce unnecessary power usage and the risk of accidents.

A blender container lid is included to prevent food items from flying out of the jar while the appliance is in use. The lid 124 snuggly fits on the upper edge of the blender container and slightly within the upper edge periphery, creating a seal between the two elements. A removable knob sits in an aperture in the lid. This knob can be removed to provide easy access to the interior volume of the container, making it easy to add small ingredients to blender.

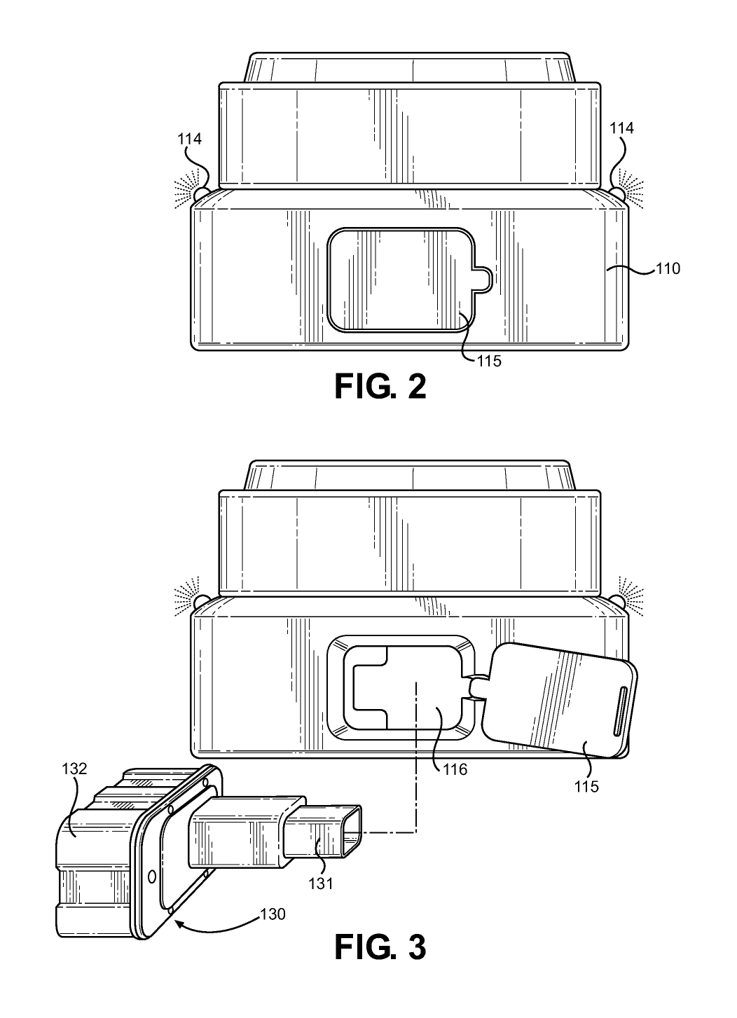

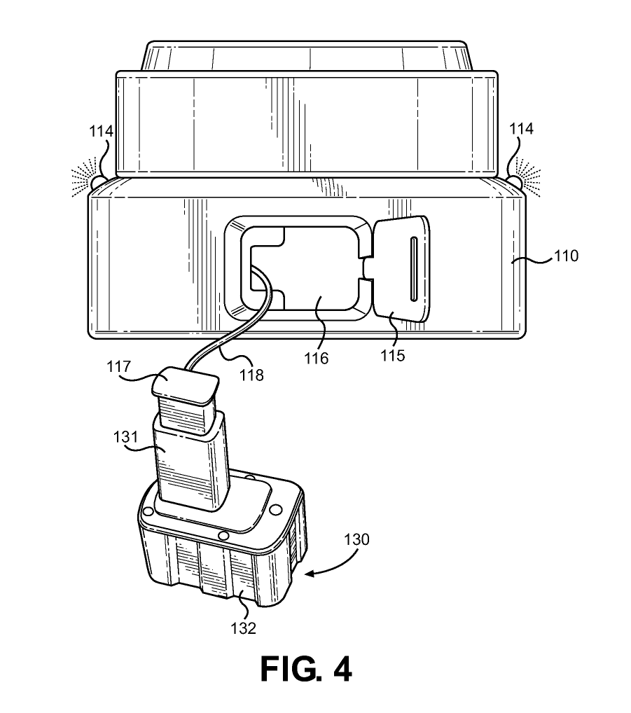

Referring now to FIG. 2, there is shown a blender base with the rear surfaces exposed. The blender base 110 tapers upward from the weighted base in a series of tiers. Two rows of indicator lights 114 are positioned on laterally opposing sides of the lower tier upper edge. A battery recess plug 115 is in place within the battery recess, to prevent dust and dirt accumulation within the recess. When in use, the battery recess is an access port providing an electrical connection between the blender motor and an inserted power tool battery.

In FIG. 3 a power tool battery is shown during insertion into the blender device. The battery access plug 115 is disengaged from the battery recess 116, revealing hinged attachment of the plug to the blender base 110 along an edge of the recess. A poor tool battery 130 can be electrically connected to the blender motor by plugging the battery's terminal shaft 131 into the battery recess. Battery terminals disposed within the shaft contact terminals disposed within the recess, facilitating the flow of electricity therebetween. Power tool batteries generally have elongated terminal shafts that extend from a large weighted base 132. The terminal shaft is inserted into the battery recess and may fit fully within the recess or may protrude slightly, depending on the model of power tool used. Conversely, the weighted base remains outside of the blender and acts as added weight to the blender base, helping keep the blender stable during use.

Lastly, there is shown an alternative embodiment of the blender having a power extension connector secured to power tool battery. The blender base 110 has a battery recess 116 and an open battery recess plug 15. A power extension connector comprising two or more wires 118 and a terminal connector 117 extends from within the battery recess. The terminal connector has a positive and negative terminal disposed on one face (not shown) that connect with the positive and negative terminals of a power tool battery. This embodiment is useful because it permit connection of batteries having terminal shafts too large to fit within the battery recess. Those batteries that do fit within the recess may be connected to the terminal connector and inserted into the recess as normal. In this manner, the individual can use any power tool battery available without worrying that the terminal shaft may be too big for the blender's battery recess.

It is also contemplated that the battery recess plug may be the battery extension connector. Thus, the plug has positive and negative terminals disposed on its underside surface, and is attaché dot the blender base via a set of wires, rather than a hinge. A separate set of terminals is disposed within the battery recess, thereby facilitating the insertion of power tool terminal shafts that will fit, while still permitting use of batteries that will not fit within the recess.

In use an individual transports the blender to a desired location such as a garage workshop, a tailgate party, or a campsite. The user then removes a battery from a nearby power tool and plugs it into the battery recess in the rear or side of the blender base. If the terminal shaft of the battery does not fit within the battery recess, the extension connector may be extracted and connected to the battery. Food items, beverages, and ice may be added to the blender container. The lid is placed firmly on the opening of the blender container and the container is then engaged with the blender base. Depending on the model of blender, the individual may need to give the blender container a twist to lock it in place on the blender base. Next the individual engages the power switch and then turns the operation dial to a desired mode of operation. Indicator lights disposed around the base will illuminate, corresponding to the mode of operation chosen, thereby providing a visual confirmation of the selection mode. Once the materials in the blender are properly liquefied, the user turns the blender off, removes the container and then the lid. The mixture is ready to serve!

The present invention is a portable blender that is adapted for use with power tool batteries. Because the invention includes a battery extension connector, the blender can be used universally with any power tool battery. Batteries whose terminal shaft fits within the blender's battery recess are preferred because the power tool battery base provides added stabilizing weight to the blender base, but all power tool batteries may be used. Indicator lights are disposed along the base and illuminate in different patterns or colors according to the current operational mode of the blender. This is not only a fun addition to the blender but also an important safety mechanism as it provides visual reference for partygoers that a blender is left on and unattended.

If so desired, the blender may contain a direct current plug that connects on one end to the blender base via a direct current port and at the other end to an outlet, wherein the outlet may provide direct current power or alternating current power that is transformed to direct current before entering the direct current port. This allows the blender to be used without batteries or facilitates battery recharging while the blender is in use.

The blender may be made of various materials, including those most commonly utilized in construction of kitchen appliances. Because it is portable, the device should be durable, and wear resistant. A high friction surface on the base underside is desirable because the blender will be placed on many different types of surfaces, some of which may be smooth and slick.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A portable blender adapted to draw power from power tool batteries, comprising:
a blender container;
a set of blender blades nested within a sealing ring and said blender container;
a container lid;
a blender base having a bottom surface, at least one sidewall, and an upper surface, and housing a motor and a drive;
a battery recess disposed on an a sidewall of said blender base and having an electrical connection to said motor;
a power flow toggling button disposed on said blender base;
a mode of operation selection dial disposed on a face of said blender base;
a plurality of indicator lights disposed along a periphery of said blender base, wherein said indicator lights are operatively connected to said selection dial such that adjustment of said selection dial changes an illumination condition of said indicator lights.

2. The device of claim 1, further comprising:
a battery extension connector, having a plurality of wires electrically connected to said motor and extending from said blender base, and having a terminal connector disposed on an end of said wires distal from said blender base, said terminal connector having positive and negative terminals disposed on one face.

3. The device of claim 2, wherein said battery extension connector extends from within said battery recess.

4. The device of claim 2, wherein said battery extension connector fits within and covers said battery recess when not in use.

5. The device of claim 1, further comprising:
a battery recess plug hingedly secured to an outer edge of said battery recess.

6. The device of claim 1, wherein said blender base tapers upward from said bottom surface to said upper surface.

7. The device of claim 1, wherein said plurality of indicator lights is two rows of lights disposed on laterally opposing sides of said blender base.
